(19) United States
(12) Patent Application Publication
(10) Pub. No.: US 2010/0166203 A1
(43) Pub. Date: Jul. 1, 2010

(54) Headset

(75) Inventors: Juergen Peissig, Hannover (DE); Bjoern Wolter, Hannover (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sennheiser Electronic GmbH & Co. KG, Wedemark (DE)

(21) Appl. No.: 12/531,951

(22) PCT Filed: Mar. 19, 2008
(86) PCT No.: PCT/EP2008/053289

§ 371 Date: Feb. 11, 2010

(30) Foreign Application Priority Data
Mar. 19, 2007 (DE) 10 2007 013 719.4

(51) Int. Cl. G10K 11/16

(52) U.S. Cl. 381/71.6

(57) ABSTRACT

There is provided an earphone comprising a first housing (LK, AK, IK) for receiving an electroacoustic transducer and a second housing (RK, AK, IK) for receiving an electroacoustic reproduction transducer, at least one outer microphone (M1) for recording outside sound and at least one inner microphone (M2) for recording sound in the region between an ear of a user and the first and/or second housings (LK, RK, AK, IK). The earphone further comprises a digital active noise reduction unit (ANR) for performing active noise reduction based on the sound recorded by the at least one outer microphone and by the at least one inner microphone. The noise reduction unit (ANR) has an analysis unit (AU) for analyzing the sound recorded by the outer microphone and the inner microphone and for determining the signal types of the recorded sound. The noise reduction unit further comprises a plurality of signal processing units (SVE1-SVEn) which are respectively adapted to perform active noise reduction for a signal type. The analysis unit (AU) selects at least one of the signal processing units (SVE1-SVEn) for performing noise reduction based on the implemented analysis of the recorded sound.

The present invention concerns a headset or earphone.

The use of active noise compensation or “active noise reduction” ANR is known both in relation to headsets and listen-talk fittings and also in relation to headphones. In that respect regulation of automatic noise reduction is not of a maximum nature in order for example to avoid feedback noise which otherwise can occur in the event of poor or variable acoustic coupling of the earphone to the head.

With the advent of digital signal processing in applications for active noise reduction in headphones, the implementation of adaptive algorithms for adaptation of the filter parameters in the noise reduction units became a possibility. In that respect active noise reduction units can have both a feedback (FB) and also a feedforward (FF) signal guide path. In that respect, the IMC structure (internal model control) is usually employed for the feedback path to implement an interaction-free interplay of feedforward FF and feedback FB components. Thus under laboratory conditions it is possible to achieve very good values on an artificial head, for attainable active damping. That structure however is found in part to be problematical on the head of a real user.

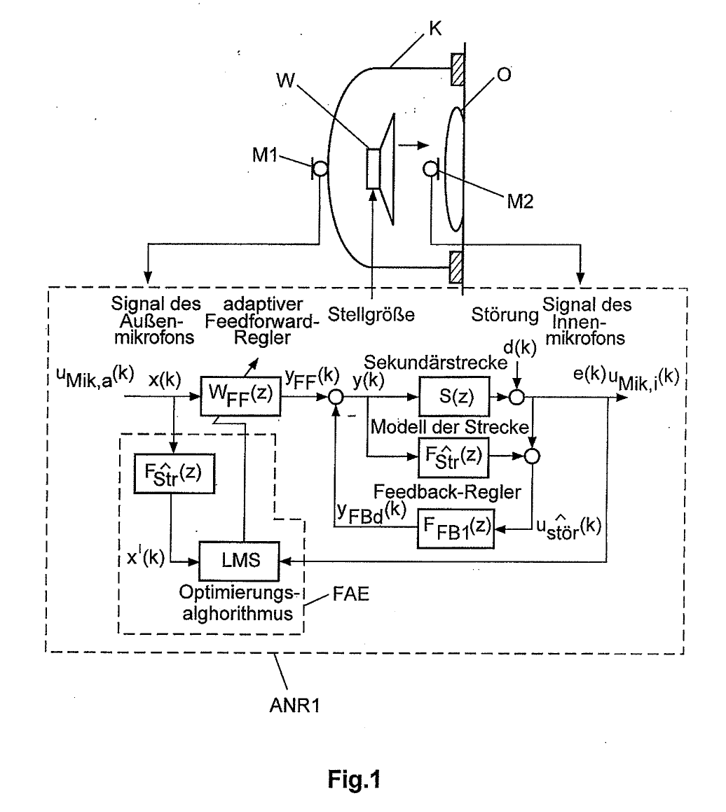

FIG. 1 shows the structure in principle of an earphone in accordance with the state of the art. The earphone includes an ear-enclosing cap K having an outer and inner microphone M1 and M2 as well as an active noise reduction unit ANR1. The active noise reduction unit ANR1 has an adaptive feedforward regulator F_{FF}(z) and a filter adaptation unit FAE for adaptation of the filter parameters of the feedforward regulator of a regulating unit. In this case a feedforward FF and a feedback FB noise reduction is combined with an IMC (interference evaluation).

The signal from the inner microphone e(k) or u_{Mik,i}(k) represents the heterodyning of the antisound with the interference d(k) and u_{stör}(k). The interference d(k) is here such that it represents a proportion of external interference noise which occurs when the regulating loudspeaker W is switched off, in the signal of the inner microphone.

The regulating circuit is described hereinafter with the FB regulator switched off. The mathematical model Ŝ(z) or F̂_{Str}(z) models the secondary section S(z) or F_{Str}(k), whose transmission characteristic arises out of the output yFF(k) of the filter WFF(z) (F_{FF}(z)) to the signal of the inner microphone e(k) or u_{Mik,i}(k). The necessary elements for amplification and AD/DA conversion are not shown here and are taken into consideration in their action in the secondary section S(z). The adaptive FF regulator WFF(z) is in the form of an FIR filter (finite impulse response) and is adapted in accordance with the known filtered-x least mean square (FxLMS) method. In that method, firstly a signal x′(k) is calculated from the signal of the outer microphone x(k) or u_{Mik,a}(k) by way of the model of the secondary section Ŝ(z), and that signal is then processed with parameter adaptation by WFF(z) in accordance with the equation:

\vec{w}_{FF}(k+1)=\vec{w}_{FF}(k)+μ·e(k)·\vec{x}′(k) (1)

with \vec{x}′(k)=[x′(k)x′(k−1) . . . x′(k−L+D)]^{T} (2)

In that case p represents the adaptation step and L the filter length. In the combination of the FF path with an FB path the FF component yFF(k) passes through the FB loop. From the view of the FF regulator that generally involves a falsified secondary section corresponding to the transmission characteristic of the closed FB regulating circuit.

Referring to FIG. 1 the feedforward FF regulator is coupled to an IMC-FB path (with interference evaluation). For interference evaluation y(k) is also put onto a model of the path Ŝ(z) in parallel relationship with the secondary section. The difference between the answer of Ŝ(z) and the measured signal of the inner microphone e(k) provides an evaluation a \hat{d}(k) for the interference d(k). The FB regulator RFBd(z) or F FB(z) then produces from \hat{d}(k) the antisignal which causes the desired extinction of the interference and compensation signal at the inner microphone. With good coincidence in respect of Ŝ(z) or F̂_{Str}(z) and S(z) or F_{Str}(z), there is also good identity in respect of \hat{d}(k) or û_{stör} and d(k) or u_{stör} so that yFBd(k) takes its origin practically exclusively in the interference d(k). The FB regulator thus does not react to the FF adjusting variable yFF(k), which ultimately leads to the FB path not altering the transmission characteristic of yFF(k) towards e(k). That thus makes it possible to have an interaction-free FF/FB combination.

The characteristic of the secondary section S(z) can fluctuate greatly in particular with varying fitment tightness of the earphone on a real head. In the case of a regulator with interference evaluation the deviations between the signals from the model and from the real path are amplified by the FB regulator and fed into FB circuit again, which can easily result in an unstable overall characteristic. To avoid that at any event the regulator RFBd(z) must be very “carefully” designed, which in the final effect leads to moderate compensation results.

Therefore the object of the present invention is to provide an earphone which permits improved active noise reduction.

That object is attained by an earphone as set forth in claim 1.

Thus there is provided an earphone comprising a first housing for receiving an electroacoustic transducer and a second housing for receiving an electroacoustic reproduction transducer, at least one outer microphone for recording outside sound and at least one inner microphone for recording sound in the region between an ear of a user and the earphone or the first and/or second housings. The earphone further comprises a digital active noise reduction unit for performing active noise reduction based on the sound recorded by the at least one outer microphone and by the at least one inner microphone. The noise reduction unit has an analysis unit for analyzing the sound recorded by the outer microphone and the inner microphone and for determining the signal types of the recorded sound. The noise reduction unit further comprises a plurality of signal processing units which are respectively adapted to perform active noise reduction for a signal type. The analysis unit selects at least one of the signal processing units for performing noise reduction based on the implemented analysis of the recorded sound.

The present invention further concerns an earphone comprising a first side having a first housing and/or a second side having a second housing for respectively receiving an electroacoustic reproduction transducer. The earphone further has at least one outer microphone at the first and/or second housing for recording outside sound. The earphone further has at least one inner microphone at the first and/or second housing for recording sound in the region between an ear of a user and the first and/or second housing. The earphone further has an active noise reduction unit for performing active noise reduction based on the sound recorded by the at least one outer microphone and by the at least one inner microphone. The active noise reduction unit is adapted to perform active noise reduction for the first side of the earphone based on the sound recorded by the outer microphone at the first side, by the inner microphone at the first side and by the outer microphone at the second side. A corresponding consideration applies to active noise reduction in respect of the second side of the earphone.

The present invention also concerns a method of performing active noise reduction at an earphone which has a first housing for receiving an electroacoustic transducer and a second housing for receiving an electroacoustic transducer, an outer microphone for recording outside sound and inner microphone for recording sound in the region between the ear of the user and the first or second housing. Active noise reduction is performed based on the sound recorded by the outer microphone and by the inner microphone. The sound recorded by the outer microphone and by the inner microphone is analyzed and the signal types of the recorded sound are determined. In addition there are provided a plurality of signal processing units for respectively performing noise reduction for a signal type. At least one of the signal processing units is selected based on the performed analysis of the recorded sound.

The invention concerns the notion of providing an earphone having a digitally adaptive interference noise suppression system which by means of adaptive filters can adapt interference noise compensation to acoustics predetermined by the fit of the earphones. That can therefore permit optimum function of the ANR system even in the case of a variable fit in respect of the earphones. That is found to be advantageous in particular when using spectacles or when the sealing integrity of the fit of the earphone is altered by a movement or by a greatly variable head shape.

Further configurations of the invention are subject-matter of the appendant claims.

Embodiments by way of example and advantages of the invention are described in greater detail hereinafter with reference to the drawing.

FIG. 1 shows a structure in principle of an earphone in accordance with the state of the art,

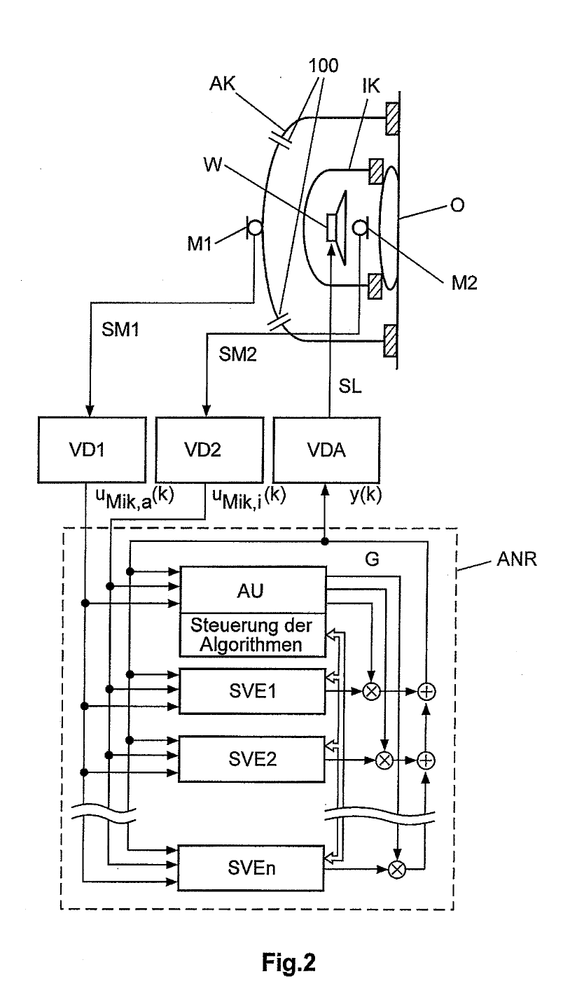

FIG. 2 shows a structure in principle of an earphone in accordance with a first embodiment,

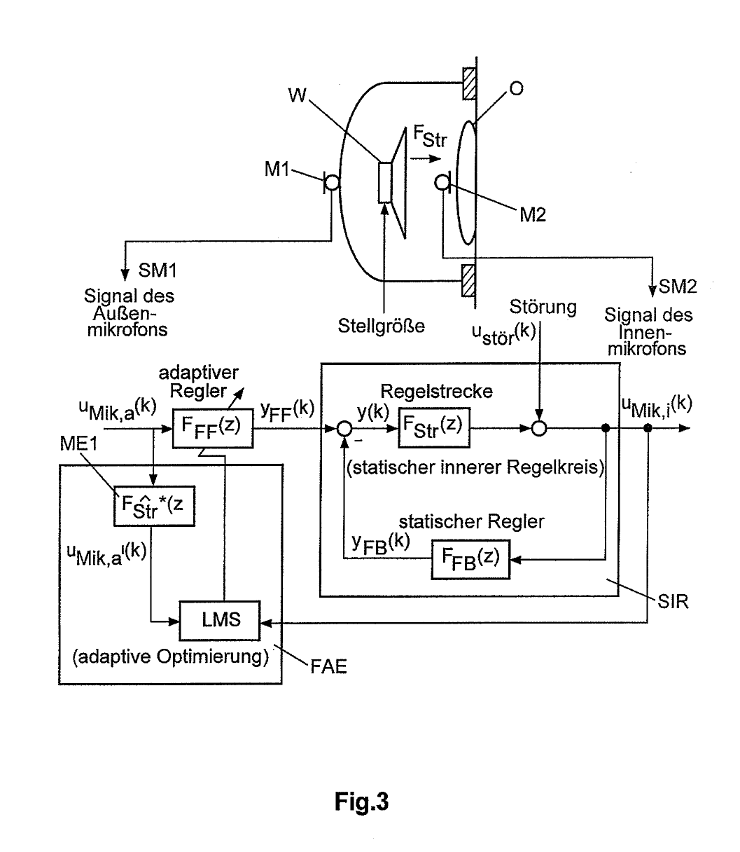

FIG. 3 shows a structure in principle of an earphone in accordance with a second embodiment,

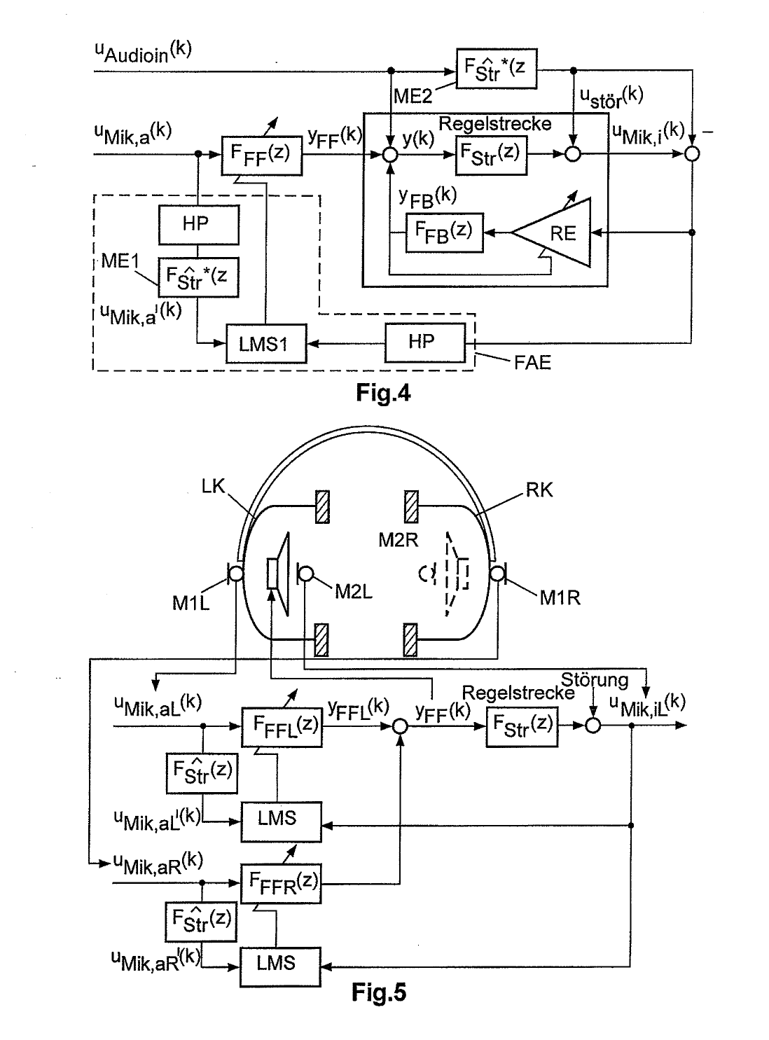

FIG. 4 shows a block circuit diagram of a regulator for an earphone in accordance with a third embodiment,

FIG. 5 shows a structure in principle of an earphone in accordance with a fifth embodiment,

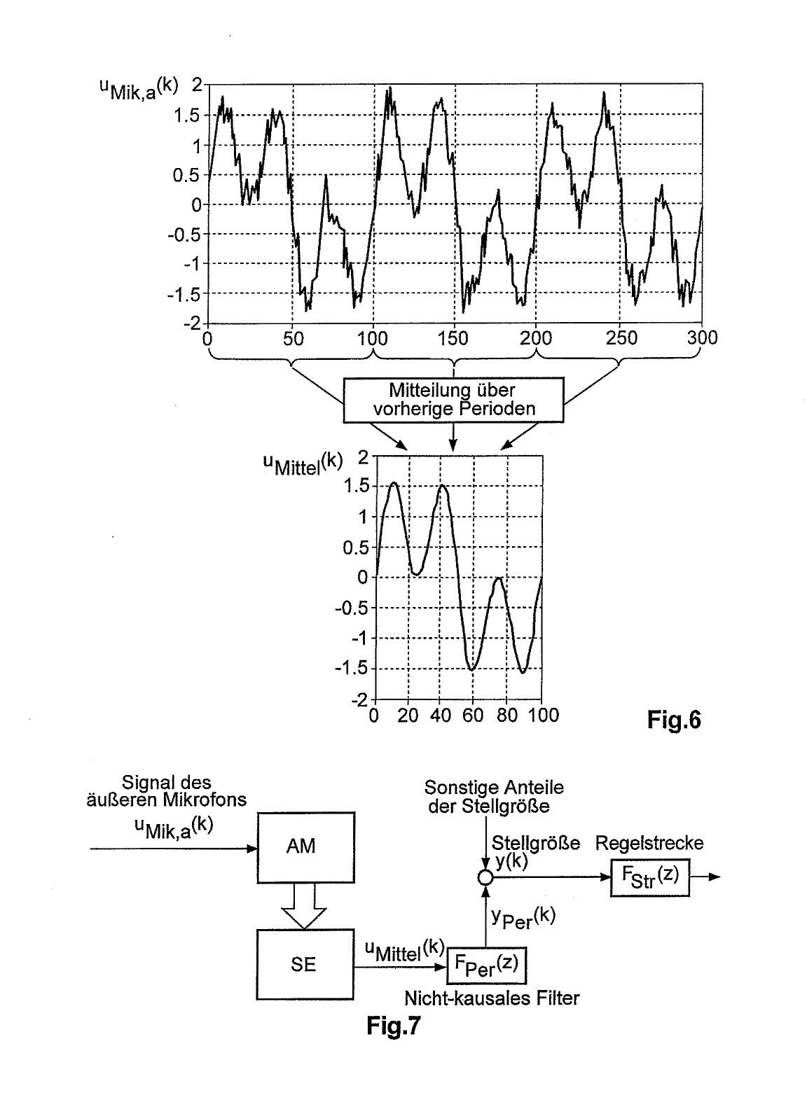

FIG. 6 shows a view of a production of a pattern prediction in accordance with a fifth embodiment, and

FIG. 7 shows a block circuit diagram of a regulator for an earphone in accordance with a fifth embodiment.

FIG. 2 shows a structure in principle of an earphone in accordance with a first embodiment. In this case the earphone has a housing with an outer cap AK, optionally an inner cap IK, a regulating loudspeaker or an electroacoustic reproduction transducer W, an outer microphone M1 and an inner microphone M2. The signals SM1 of the outer microphone M1 are passed to a first amplification and A/D converter unit VAD1 which amplifies the signals and subjects the signals SM1 to A/D conversion and outputs a digital signal u_{Mik,a} (k). The signals SM2 from the inner microphone M2 are passed to a second amplification and A/D converter unit VAD2 and outputted as a digital signal u_{Mik,i} (k). The output signals of the first and second amplification and A/D converter units are outputted to an analysis unit AU which analyzes the signals to be able to associate the signals with corresponding signal types. The earphone has a noise reduction unit ANR for implementing active noise compensation or active noise reduction. The active noise reduction unit ANR has the analysis unit AU and a plurality of signal processing units SVE1-SVEn which are respectively adapted to implement active noise reduction for a given signal type. On the basis of the signal analysis of the output signals u_{Mik,a} (k), u_{Mik,i} (k), effected by the analysis unit AU, the signal processing units SVE1-SVEn are selected and activated. The analysis unit AU can further compute a weighting G with which the respective output signals from the signal processing units SVE1-SVEn are weighted. The weighted output signals of the signal processing units SVE1-SVEn are added and form the adjusting variable y(k) which is passed to an amplification and D/A converter unit VDA which outputs an adjusting variable SL for the regulating loudspeaker W.

The outer microphone M1 serves for acquisition of the outside sound.

The inner microphone M2 serves for acquiring the sound in the proximity of the entrance to the ear, that is to say therefore the sound is acquired at the ear of the wearer. The active noise reduction unit ANR, based on the amplified and A/D-converted signals from the outer microphone M1 and the inner microphone M2, produces an adjusting variable for driving the regulating loudspeaker W. It is an aim of that active noise reduction for the signal u_{Mik,i} (k), that is to say the acoustic pressure at the entrance to the ear, to be minimized by regulation of the adjusting variable y(k).

The analysis unit AU analyzes the signals from the outer microphone M1 and the inner microphone M2 to acquire the signal types detected therein. Then some of the signal processing units SVE1-SVEn are activated, which are respectively adapted to provide for optimum processing of a given signal type in order to effect optimum noise reduction.

It is thus possible by means of the analysis unit AU to react to different scenarios in respect of interference noise, and the interference noises can be compensated based on their short-term or long-term structure, with different noise reduction signal processing strategies. Thus for example the first signal processing unit SVE1 can be adapted to process periodic signals while the second signal processing unit SVE2 can process stochastic signals to permit corresponding noise reduction. The first signal processing unit can for example compensate for periodically occurring interference insofar as a prediction can be made for the future interference pattern and that prediction can be taken into consideration in respect of noise reduction. In contrast the second signal processing unit SVE2 only evaluates the pattern of the signals up to current moment in time to produce a reduction signal.

Optimum noise reduction can be achieved by virtue of the fact that corresponding signal processing units SVE1-SVEn are provided for a multiplicity of signal types, those units being designed for specific processing of precisely that signal type. In that respect however it is important that the analysis unit AU recognizes the different signal types (such as for example wideband, noise-like, pulsed, periodic or the like) and actuates a corresponding one of the signal processing units SVE1-SVEn. The various signal processing units are adapted in particular to carry out different noise reduction algorithms. In that respect the various signal processing units can operate in parallel or serial mode. Actuation of the different signal processing units is effected by the analysis unit based on the detected signal types of the input signals. The analysis unit AU can also actuate a plurality of the signal processing units in parallel and provide corresponding weighting of the respective output signals.

The algorithms processed in the signal processing units SVE1-SVEn are non-linear and time-variant. In order however to avoid interactions between the coupled signal processing units the analysis unit AU is adapted to implement those interactions (for example if sum interference noise reductions are much less than the individual interference noise reduction) and possibly in an interference situation to influence the cooperation of the individual signal processing units. For that purpose the output signal y(k) of the active noise reduction unit is fed back to the analysis unit AU.

FIG. 3 shows a structure in principle of an earphone in accordance with a second embodiment. As in the first embodiment the earphone has a housing, a regulating loudspeaker or an electroacoustic reproduction transducer W, an outer microphone M1 and an inner microphone M2. The signals SM1, SM2 of the outer microphone M1 and the inner microphone M2 are amplified and subjected to A/D conversion by first and second amplification and A/D converter units VAD1, VAD2 (not shown). Regulation of the active noise reduction in accordance with this embodiment is based on an adaptive wideband feedforward/feedback combination. The earphone has a static inner regulating circuit SIR based on the regulating section F_{Str} (z) and a feedback path F_{FB} (z). The regulating section required for that purpose is defined by the transfer characteristic F_{Str} (z) (input signal: y(k) and output signal: u_{Mik,i} (k)). There is also a feedforward path and a feedback path. The feedforward path has a filter F_{FF} (z) which supplies a component y_{FF} (k) for the adjusting variable, from the amplified and A/D converted signal u_{Mik,a} (k) of the outer microphone M1. The feedback path has a further filter F_{FB} (z) which delivers a component y_{FB} (k) for the adjusting variable from the amplified and A/D converted signal from the inner microphone M2. In that case the component of the adjusting variable y_{FB} (k) of the feedback path is subtracted from that of the adjusting variable y_{FF} (k) to obtain the overall adjusting variable y(k).

The filter F_{FF} (z) in the feedforward path is preferably in the form of an adaptive FIR (finite impulse response) filter. Preferably in that case the filter parameters are adapted to the currently prevailing factors involved. That can be effected for example by evaluation of the signals of the outside sound u_{Mik,a} (k) and the inside sound u_{Mik,i} (k), based on an optimization algorithm. Adaptation of the filter parameters of the feedforward filter is preferably effected in the filter adaptation unit FAE. In that case modification of the parameters of the feedforward filter F_{FF} (z) can be effected in each sampling step. The filter adaptation unit has the outside sound u_{Mik,a} (k) and the inside sound u_{Mik,i} (k) as input parameters and outputs the filter parameter values for the feedforward filter F_{FF} (z). For that purpose the filter adaptation unit FAE has a model unit ME in which a mathematical model F̂_{Str}*(z) of the regulating section F_{Str} (z) is stored. While the inner regulating circuit in accordance with the state of the art in FIG. 1 has a secondary section S(z) or F_{Str} (z), a model of the secondary section F̂_{Str} (z) and a feedback regulator F_{FB1} (z) and thus the estimation of the regulating section is effected in the inner regulating circuit, the regulator in accordance with the second embodiment dispenses with an estimation of the section in the inner regulating circuit. For that purpose the mathematic model of the regulating section, that is stored in the model unit ME1, is adapted to the new inner regulating circuit. An output signal u_{Mik,a}′(k) is formed in the model unit ME based on that adapted mathematical model and the input parameter (outside sound u_{Mik,a} (k)). The filter adaptation unit FAE further has a unit LMS for performing the LMS method (least mean square) which is adapted to link old values in respect of the output signals of the model unit to current values of the inside sound u_{Mik,i} (k) to compute new parameter values for the feedforward filter.

The mathematical model stored in the model unit ME1 corresponds to the following equation:

F̂_{Str}*(z)=F_{Str}(z)/(1+F_{Str}(z)*F_{FB1}(z))

The active noise reduction unit shown in FIG. 3 can ensure that there is no model of the regulating section disposed directly in the signal path. There is only an adapted model in the filter adaptation unit for adaptation of the filter parameters. Thus there is provided a regulating circuit having a regulating section and a feedback path. By virtue of that design configuration stability analysis of the regulator is simpler than in the case of the regulator shown in FIG. 1.

The mathematical model stored in the model unit ME takes account of the feedback path F_{FB} (z) so that the combination of the adaptive feedforward path with the feedback path is made possible, without fault-susceptible estimation of the interference. The feedback filter F_{FB} (z) is not of an adaptive configuration, as shown in FIG. 3.

As an alternative thereto a limited number of various parameter sets can be predetermined for the feedback filter F_{FB} (z), the parameter sets being respectively adapted to a given region of the transmission section. During operation the system is switched over between those parameter sets, based on the behavior of the transmission section. A mathematic model can be established and stored in the model unit ME for each of those parameter sets.

FIG. 4 shows a regulator in accordance with a third embodiment. The regulator of the third embodiment is based on the regulator of FIG. 3. In this case the filter adaptation unit FAE further has two high pass filters HP. The regulator shown in FIG. 3 serves in particular for frequency-selective adaptation. Before the signal u_{Mik,i} (k) is subjected to the optimization algorithm in the filter adaptation unit high-pass filtering is effected in the high pass filter HP so that the low frequencies which occur for example due to movements of the head are filtered out. However so that adaptation of the parameters of the feed forward filter F_{FF} (z), that is effected by the filter adaptation unit FAE, is maintained, a further high pass filter HP is provided upstream of the LMS unit. The two high pass filters HP are identical in design for that purpose.

Filter adaptation can thus be to a desired frequency range by means of the regulator shown in FIG. 4. As an alternative to a high pass filter it is also possible to provide another filter such as for example a band pass filter to provide a given frequency range for adaptation. The FIG. 4 regulator makes it possible to compensate for negative effects on ANR, which occur due to movements between the head of a wearer of an earphone and the earphone.

The accelerations between head and earphone, caused by movement can give rise to pressure fluctuations in the interior of the earphone, which typically involve low frequencies of up to about 15 Hz. Although those frequencies are not audible they can produce high amplitudes and can be detected by the inner microphone as part of the acoustic signal. Typically minimization of the energy of the inside sound u_{Mik,i} (k) is desired in the case of the adaptation algorithm for the feedforward filter. As the low frequencies however can be of a high amplitude the energy content of the inside sound u_{Mik,i} (k) can be greatly determined by low-frequency pressure fluctuations. Therefore the adaptation algorithm will try to adapt the feedforward filter F_{FF} (z) in such a way that those signals caused by the movement are compensated. In contrast thereto however the output signal y_{FF} (k) of the feedforward filter is only produced by filtering of the signal of the outer microphone u_{Mik,a} (k). The pressure fluctuations caused by the movement however only occur in the interior of the earphone so that the signals of the outer microphone do not have those components and compensation cannot be effected in the feedforward path.

The FIG. 4 regulator can also be used in a headset or a listen-talk fitting, in which case a useful signal U_{AudioIn} (k) can be fed in. That signal can represent for example a communication signal. The useful signal is added directly to the adjusting variable y(k) for actuation of the loudspeaker W so that the desired useful signal can be reproduced by the transducer. To prevent the useful signal being perceived as interference and correspondingly suppressed the useful signal is applied in parallel to a second model unit ME2 with a mathematical model of the transmission section and the computed useful component of the signal subtracted from the inside sound u_{Mik,i} (k).

If however there is a deviation between the model of the transmission section and the actual transmission section (for example due to movements between the head and the earphone) that deviation can be detected as interference, by active noise reduction. As however active noise reduction is based on the model F̂_{Str} (z) of the regulating section, that is stored in the second model unit, the transmission characteristic of the useful signal is adapted to the mathematical model. The consequence of this is that the altered fit of the earphone is less noticed by the user, due to the presence of the active noise reduction, than without active noise reduction.

To prevent overdriving of the loudspeaker by the active noise reduction the arrangement has a reducing unit RE in the feedback path of the internal regulating circuit. In this case the reducing unit RE is designed in such a way that it typically involves a value of 1. If however the signal y_{FB} (k) of the feedback path reaches an overdriving limit the value of the reducing unit is reduced so that the amplification of the feedback component is reduced. That means that the effect of active noise reduction is reduced without overdriving noises being passed to the loudspeaker. The reducing unit RE further preferably has an adjustable time constant so that the factor of the reducing unit can again approach the value 1 when there is no further risk of overdriving.

Additionally or alternatively thereto the filter adaptation unit FAE can also be adapted as adaptation of the signal u_{Mik,a} (k) leads to an increase in the parameters of the feedforward filter. Therefore the LMS unit LMS1 is provided with what is referred to as a leak factor. If there is no risk of overdriving of the loudspeaker the leak factor is 1. In the LMS unit LMS1 shown in FIG. 4 the previous value of the parameters is multiplied in each sampling step by the leak factor before the modification component is added thereto. The leak factor is reduced in size if the component y_{FF} (k) of the feedforward path at the adjusting variable approaches the overdriving limit. The FIR parameters are reduced in the direction of zero by that multiplication by a reduced leak factor so that the amplitude of y_{FF}(k) does not exceed the overdriving limits. Similarly as in the case of the reducing unit RE there can be an adjustable time constant for the leak factor so that the leak factor approaches the value 1 when there is no risk of overdriving.

FIG. 5 shows a structure in principle of an earphone in accordance with a fourth embodiment. In this case the earphone has a housing with a left cap LK and a right cap RK. There are also outer microphones M1L, M1R and inner microphones M2L, M2R, and two transducers W. The signals of the outer microphone M1L at the left cap u_{Mik,a} L(k) and the signals of the outer microphone M1R at the right cap are fed to a left and a right arm of the regulating system. However only compensation for the left earphone is shown for illustration purposes in FIG. 5. Compensation for the right earphone is effected similarly thereto.

Thus the adjusting variable y_{FF} (k) is composed of a left component y_{FFL} (k) (from the left outer microphone) and a right component y_{FFR} (k) (from the right outer microphone). Both filters F_{FFL} (z) and F_{FFR} (z) are in the form of adaptive FIR filters. The filter F_{FFL} (z) takes account of the signals u_{Mik,a} L (k) and u_{Mik,i} L (k), that is to say the signals of the left outer microphone and the left inner microphone. In the case of the filter F_{FFR} (z) the signal of the right outer microphone M1R is processed with the signal u_{Mik,i} L (k) of the left inner microphone M2L. Improved compensation results can be achieved by such a combination. That applies in particular when simple feedforward processing does not lead to the desired aim as a signal at an outer microphone of an earphone occurs only when the signal has already reached the inner microphone, as occurs for example in the case of sound irradiation from the opposite side. That also has the advantage that the outer microphone used on the second side, that is to say the opposite side, detects the interference signal rather than the microphone on the first side, that is to say its own side, so that the reaction time is increased.

In addition to the configuration shown in FIG. 5 a feedback path can also be provided.

FIG. 6 shows a view of production of a pattern prediction in accordance with a fifth embodiment. If active noise reduction is to be effected in areas of use with dominant periodic signals such as for example generator noises, engine noise, turbine noises, the noise can be particularly effectively reduced when a signal delayed by a period is acoustically added in inverted-phase relationship to the original sound. In order to be able to produce the delayed signal however precise recognition of the dominant periodic sound components is required. That is effected for example in the analysis unit shown in FIG. 1. In that case it is possible to ascertain for example a period length in order then to produce an averaged pattern u_{Average} (k) from the preceding periods of the signal at the outer microphone. If the interference sound includes for example a periodic signal of a length of 100 sampling steps then the new signal is composed of 100 values, wherein each of those 100 values represents an average value from the measured sampling values which were measured before 100, 200 or 300 and so forth. The signal u_{Average} (k) shown in FIG. 6 thus represents the periodic component of the interference signal including all harmonics. It should be noted in this respect that additionally present stochastic components are removed by the averaging. Thus the signal u_{Average} (k) specifies the future pattern of the interference signal.

The pattern prediction in accordance with the fifth embodiment can be implemented for example in one of the signal processing units in accordance with the first embodiment.

FIG. 7 shows a block circuit diagram of a regulator for periodic signals in accordance with the fifth embodiment. The regulator has an analysis and averaging unit AM, a signal production unit SE and a filter F_{Per} (z). The cyclically continued signal u_{Average} (k) serves as an input signal for the filter F_{Per} (z) to produce a counter-signal y_{Per} (k) for the periodic components. The counter-signal y_{Per} (k) is then superimposed with further components of the adjusting variable.

By virtue of signal processing as shown in FIG. 7 the filter F_{Per} (z) can have access to future values of known input signals so that that filter can initiate the production of the antisound before the interference noise has been detected at all. That is advantageous in particular in respect of higher frequencies.

Although in accordance with the fifth embodiment only averaging based on preceding parameters in the feedforward path has been described that can also be applied in regard to evaluation of the signals of the inner microphone U_{Mik,i} (k) on the feedback path.

The structure described with reference to FIG. 7 can be implemented for example in the structure described with reference to FIG. 2 of the active noise reduction device as one of the signal processing units SVE1-SVEn.

In accordance with a sixth embodiment of the invention the earphone has a housing with an inner cap IK and an outer cap AK. That described for example in FIG. 2. In this case the outer cap AK performs a function of passive noise protection by the noise being passively damped. The outer cap AK can be acoustically optimised in respect of passive noise reduction for example in respect of a sealed fit, an ear-enclosing inner volume, a heavy material and a thick wall thickness. The inner cap IK can be for example of a design such as to bear against an ear and can thus be of a smaller inside volume which permits a more advantageous starting condition for matching of active noise reduction with the transducer W. In this case the inner cap IK is preferably movably fixed to the outer cap AK in such a way that it can adapt its shape to the form of the ears of different wearers. In addition acoustic decoupling between the outer cap and the inner cap is preferably achieved.

By virtue of the two decoupled caps, both good passive damping and also a desirable prerequisite for active noise reduction can be made possible in a single earphone.

Optionally the outer cap can have openings 100 which for example can serve to reduce pressure fluctuations in the interior of the cap, which can be produced by movements of the head. Both an increased pressure and also a reduced pressure can escape through the openings 100. Those holes are predominantly relevant for low frequencies while audible frequency components remain unchanged. The frequency range in which the openings influence the pressure in the interior of the cap can be adjusted by the configuration of the openings 100.

In accordance with a seventh embodiment the inner microphone is arranged at a predetermined spacing relative to the regulating loudspeaker W.

While the inner microphone in accordance with the state of the art is positioned as closely as possible to the loudspeaker in order to reduce the dead time caused by the predetermined spacing relative to the loudspeaker W and the inner microphone and the speed of sound, the inner microphone in accordance with a eighth embodiment is placed as close as possible to the entrance to the ear. The reduction in the spacing between the loudspeaker and the inner microphone in accordance with the state of the art is effected to counteract a shift in the phase position between the input signal y(k) and the output signal u_{Mik,i}(k) of the regulating section. As however in accordance with the eighth embodiment the energy in the inside sound u_{Mik,i}(k) is to be reduced to achieve a reduction in the noise at the eardrum it is more appropriate for the inner microphone to be placed as close as possible to the entrance to the ear.

By way of example the inner microphone can be arranged in an earplug worn in the auditory canal while an earphone with an outer microphone is worn on the head.

As already explained hereinbefore arranging the inner microphone in the proximity of the entrance to the ear has a negative effect on compensation of higher frequencies in the feedback path. If however frequency-selective adaptation of the filter parameters, described with reference to FIG. 4, is effected in the case of an earphone with the inner microphone in the proximity of the entrance to the ear, it is possible to compensate for the above-described lack of compensation. For that purpose the feedback path can be designed for low frequencies (at which the dead time is not excessively significant) while the feedforward path serves for the compensation of high frequencies.

The design configuration of the inner microphone in accordance with the seventh embodiment can be combined for example together with the regulator shown in FIG. 4.

In accordance with an eighth embodiment the feedback path is not digital but analog. That has in particular the advantage that A/D conversion and D/A conversion is no longer required, which makes compensation by the feedback path faster and thus better. In addition an analog implementation of an antisound filter has a lower transit time, a lower level of complexity, a lower energy consumption and involves lower costs. Furthermore an analog implementation of the feedback path can be provided, in which case the filter properties are digitally controlled.

It is thus possible to achieve a hybrid configuration, wherein the filters are analog but adaptation of the filters (modification to the filter parameters) is effected by a digital monitoring unit.

1. An earphone comprising
a first housing (LK, AK, IK) for receiving an electroacoustic reproduction transducer and a second housing (RK, AK, IK) for receiving an electroacoustic reproduction transducer (L),
at least one outer microphone (M1) for recording outside sound,
at least one inner microphone (M2) for recording sound in the region between an ear of a user and the first or second housings (LK, RK, AK, IK), and
a digital active noise reduction unit (ANR) for performing active noise reduction based on the sound recorded by the at least one outer microphone and by the at least one inner microphone,
wherein the noise reduction unit (ANR) has an analysis unit (AU) for analyzing the sound recorded by the outer microphone and the inner microphone and for determining the signal types of the recorded sound and a plurality of signal processing units (SVE1-SVEn) which are respectively adapted to perform noise reduction for a signal type,
wherein the analysis unit (AU) selects at least one of the signal processing units (SVE1-SVEn) for performing noise reduction based on the implemented analysis of the recorded sound.

2. An earphone as set forth in claim 1 wherein the analysis unit (AU) is adapted to weight the output signals of the signal processing units (SVE1-SVEn).

3. An earphone as set forth in claim 1 wherein one of the signal processing units (SVE1-SVEn) has a feedforward path and a feedback path, wherein a first adaptive filter (F_{FF}(z)) is provided in the feedforward path,
wherein the signal processing unit (SVE1-SVEn) has a filter adaptation unit (FAE) for ascertaining the filter parameters of the first filter (F_{FF}(z)) based on the sound recorded by the outer microphone (M1) and the inner microphone (M2).

4. An earphone in particular as set forth in claim 1, comprising
a first side (L) having a first housing (LK) and/or a second side (R) having a second housing (RK) for respectively receiving an electroacoustic reproduction transducer (W), at least one outer microphone (M1) at the first and/or second housing (LK, RK) for recording outside sound,
at least one inner microphone (M2) at the first and/or second housing (LK, RK) for recording sound in the region between an ear of a user and the left and/or right housing (LK, RK) of the earphone, and
an active noise reduction unit (ANR) for performing active noise reduction based on the sound recorded by the at least one outer microphone and by the at least one inner microphone,
wherein the active noise reduction unit (ANR) is adapted to perform active noise reduction for the first side of the earphone based on the sound recorded by the outer microphone (M1L) at the first housing, by the inner microphone (M2L) at the first housing and by the outer microphone (M1R) at the second housing, and/or
wherein the active noise reduction unit (ANR) is adapted to perform active noise reduction for the second side of the earphone based on the sound recorded by the outer microphone (M1L) at the second housing, by the inner microphone (M2L) at the second housing and by the outer microphone (M1R) at the first housing.

5. An earphone as set forth in claim 4 wherein the active noise reduction unit (ANR) has a feedforward path with a first adaptive filter (F_{FF}(z)) and a filter adaptation unit (FAE) for ascertaining the filter parameters of the first filter (F_{FF}(z)) based on the sound recorded by the outer microphone (M1) and the inner microphone (M2).

6. An earphone, in particular as set forth in claim 1, comprising
at least one loudspeaker (W),
at least one outer microphone (M1) for recording outside sound,
at least one inner microphone (M2) for recording sound in the region of between an ear of a user and the earphone, and
an active noise reduction unit (ANR) for effecting active noise reduction based on the sound recorded by the at least one outer microphone and by the at least one inner microphone,
wherein the active noise reduction unit (ANR) has a feedforward path with a first adaptive filter (F_{FF}(z)), a filter adaptation unit (FAE) for ascertaining the filter parameters of the first filter (F_{FF}(z)) based on the sound recorded by the outer microphone (M1) and the inner microphone (M2), and an inner regulating circuit (IR),
wherein the inner regulating circuit (IR) has a first regulating unit (F_{Str}(z)) and a feedback regulating unit (F_{FB}(z)), wherein the output of the first regulating unit is coupled to the input of the feedback regulating unit, and wherein subtraction of the output of the feedback regulating unit from the output of the first adaptive filter (F_{FF}(z)) represents the input of the first regulating unit.

7. An earphone as set forth in claim 6 wherein the filter adaptation unit (FAE) has a model unit (F̂_{Str}*(z)) for storing a mathematical model of the inner regulating circuit and for estimating the properties of the inner regulating circuit as well as an adaptation unit, wherein the adaptation unit is adapted to perform adapted filter parameters based on the sound recorded by the inner microphone and the output of the model unit in accordance with the least mean square method.

8. An earphone as set forth in claim 6 wherein the filter adaptation unit (FAE) has a first frequency-selective filter (HP) for frequency-elective filtering of the sound recorded by the outer microphone and a second frequency-selective filter (HP) for frequency-selective filtering of the sound recorded by the inner microphone.

9. An earphone comprising
an inner cap (IK) for bearing against an ear and an outer cap (AK) for enclosing an ear, wherein the inner cap has a loudspeaker (W) and an inner microphone (M2), and wherein an outer microphone (M1) for recording outside sound is arranged at the outer cap (AK), and
an active noise reduction unit (ANR) for performing active noise reduction based on the sound recorded by the at least one outer microphone and by the at least one inner microphone.

10. An earphone as set forth in claim 9 wherein the inner and outer caps are decoupled from each other.

11. A method of active noise reduction of an earphone having a first housing (LK, AK, IK) for receiving an electroacoustic reproduction transducer and a second housing (RK, AK, IK) for receiving an electroacoustic reproduction transducer, an outer microphone (M1) for recording outside sound and an inner microphone for recording sound in the region between an ear of a user and the first or second housing, comprising the steps:
performing active noise reduction based on the sound recorded by the outer microphone and by the inner microphone,
analyzing the sound recorded by the outer microphone and by the inner microphone,
determining the signal types of the recorded sound,
providing a plurality of signal processing units for respectively performing noise reduction for a signal type, and
selecting one of the signal processing units for performing noise reduction based on the implemented analysis of the recorded sound.
